(19) United States
(12) Patent Application Publication
(10) Pub. No.: US 2003/0074557 A1
(43) Pub. Date: Apr. 17, 2003

(54) Method and system for management of properties

(75) Inventor: Harri Vatanen, Surrey (GB)

Correspondence Address: COHEN, PONTANI, LIEBERMAN & PAVANE, Suite 1210, 551 Fifth Avenue, New York, NY, 10176, US

(73) Assignee: Sonera Smarttrust Oy

(21) Appl. No.: 10/137,890

(22) Filed: May 2, 2002

Related U.S. Application Data
(63) Continuation of application No. PCT/FI00/00968, filed on Nov. 6, 2000.

(30) Foreign Application Priority Data
Nov. 4, 1999 (FI) FI19992387

(51) Int. Cl. H04L 9/00

(52) U.S. Cl. 713/168

(57) ABSTRACT

A method and a system for managing property such as articles, devices, apparatus, systems or information. The system includes a database (DB) for storing information relating to the property and its owner. An unambiguous identifier that individualizes the property is created based on information attached to the property; the identifier is saved to a database and is entered into the database as certified after fulfillment of a predetermined condition. Before it is saved to the database, the identifier is digitally signed using a certified signing key and data of the property owner is attached to the digitally signed identifier.

### BACKGROUND OF THE INVENTION

1. Field of the Invention

The present invention relates generally to telecommunications. In particular, the invention is directed to methods and systems for the management of property—i.e. an “object” such as an article, device apparatus, system or information—in which an unambiguous identifier individualizing the object is created based on data or information attached to the object, the identifier is saved to a database, and the identifier is entered in the database as certified after fulfillment of a predetermined condition.

2. Description of Related Art

Some devices and vehicles, such for example telecommunication stations or terminals and automobiles, are typically equipped with a serial number that helps to uniquely identify the particular object or article. The serial number is marked or attached to the object in such a way that it is effectively impossible to remove or change it without detection. Thus, a serial number renders it possible to confirm or verify, for example, the place and/or date of manufacture of the associated object.

Insurance companies and like entities commonly store and retain a record of the various devices and/or vehicles marked by a customer; the term “security marking” is often used in this context. The so individualized object is often provided with a specific marking, or a separate component that helps to uniquely identify the object and that is very difficult to detach may be inserted in or on or attached to the object. It is in this manner possible, in the event of its loss or theft, to identify the real owner of the property if and when the missing article is found.

There currently exist a variety of commercially-available services that, for a relatively small annual fee, will reimburse the owner for the insurance deductible should an article be stolen; such services, however, necessarily require that the article has been insured and has been marked as instructed by the insurance company, or that a unique identifier specified by the insurance company has been inserted in or affixed to the article or object.

One of the most important questions concerning the Internet relates to its safety as a secure communication medium. The desired objective is to be able to transmit sensitive information via the Internet in a secure and protected manner. One of the tools for achieving this goal is public key encryption infrastructure—a system based on the use of separate keys (i.e. a key pair) for encryption and decryption, wherein one of the keys is mathematically dependent on the other so that a piece of information encrypted with one (the so-called public key) can only be decrypted using the other (the so-called secret or private key) of the same public-private key pair. The public key may thus be freely distributed to anyone needing the key to encode a message or data, and the user can create, for his or her own use, separate key pairs for signature (i.e. digital signing) and encryption. In signing keys, the private key is commonly employed by the key pair owner to digitally sign the information or data, and the public key is used by a recipient third party to confirm the identity of the digital signatory—i.e. to confirm the private key that was used to digitally sign the information or data.

The effective use of such asymmetric encryption methods requires a dependable manner or system of distribution of public keys. Users of public keys must be certain that the public keys being distributed actually belong to the parties to whom they are claimed or alleged to belong. It is in this context that the term “public key infrastructure” (PKI) is commonly employed. The public key infrastructure generally comprises trusted third parties (TTPs) and certificate authorities (CAs) whose activities are intended to maintain and assure the integrity of the system.

As used herein, and as is generally known, the term “trusted third party” denotes, by way of illustrative example, a security authority (or an entity authorized or appointed by a security authority) on whom the users depend and who offers security-related services, but may also be understood as a more generalized concept that encompasses certificate authorities, and certification and registering parties and the like. A certificate authority or certification party is an authority or authorized entity that creates and signs security certificates, and may also act as a creator of the keys.

The basic services of the public key infrastructure include the creation of keys, the registering of users, the certification of public keys, the publishing of public keys and certificates, and the updating and publishing of revocation lists.

A particularly troublesome and significant unsolved problem in this context at the present time is the lack of any effective mechanism or arrangement for safely, easily and with sufficient certainty registering, and establishing or demonstrating with certainty, that specific property belongs to a particular person or entity.

### OBJECTS AND SUMMARY OF THE INVENTION

It is accordingly the desideratum of the present invention to eliminate or at least significantly alleviate the problems and deficiencies, including those discussed hereinabove, of prior art methods and systems for establishing a person's or entity's ownership or authorized control of particular property or articles.

It is a particular object of the invention to provide a method and system enabling the safe, secure and ready registration of information concerning particular property.

The present invention accordingly provides, inter alia, a method for managing of property such as an article, device, apparatus, system or information. In accordance with the invention, an unambiguous object-individualizing identifier is created based on information attached to the object. The term “identifier” is intended to denote, by way of illustrative example, a serial number or other individualizing identifier. The identifier is saved to a database and is entered in the database as being certified after the fulfilment of a predetermined condition.

In accordance with the invention, before saving the identifier to the database the identifier is signed with a certified signing key and the data of the signatory are attached to the signed identifier. The signed identifier may be transmitted to the database, as via an arranged telecommunication connection. For this purpose, the signed identifier can be encrypted with the public key of the recipient, who can then reverse or decode the encryption with the recipient's private key.

The validity of the signing key of the signatory can then be checked. If the key is determined to not be valid, then the identifier is provided with a notification that the key has expired. If the signing key is, on the other hand, determined to be valid, then the identifier may be entered as certified.

When creating the private signing and/or encryption key of the signatory and the corresponding public key(s), the keys may be certified using a certificate issued by a trusted third party. This procedure makes it possible, based on the certification, to assure that the keys actually belong to the entity to which they are said to belong. The identifier in the database and/or the details attached to the identifier may also be signed using the public signing key of the trusted third party, thus guaranteeing that the signed information cannot be unknowingly altered.

The signature connected with the identifier or the data of the signatory can be checked to determine or identify the owner of the property. The identifier, and the data of the signatory connected with the identifier, can also be eliminated from the database where, for example, the owner who has registered the property in his or her name is no longer the owner.

Signed and/or encrypted information can also be transmitted between the signatory and the database via the telecommunication connection. A mobile station or other terminal device may be used for digital signing and/or encryption of information, and/or for decoding thereof.

The present invention additionally provides a system that includes a database which contains details of property registered in the database. The system further includes signing equipment for digitally signing the identifier with the certified public signing key, and a modifier for attaching data of the signatory to the signed identifier.

The inventive system may also include one or more of a first checker for verifying the validity of the signing key of the signatory, a known third party, and a second checker for verifying, using the database, the signature connected with the identifier.

The inventive system may additionally include a mobile station that is used for the signing of information and/or the encryption or decoding of such information, and/or may include a telecommunication connection by and along which the signed and/or encrypted information is transmitted.

As a consequence of the present invention, the management of property may be so implemented that the property owner may with certainty point out his or her property and safely and securely transmit ownership-related information to an entity providing property management services. The invention further enables one to clarify and establish ownership of property, as for example by a potential purchaser when the property is for sale.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings:

FIG. 1 is a block diagram of a system constructed in accordance with the invention; and

FIG. 2 is a flow chart depicting a method in accordance with and implementing the invention.

### DETAILED DESCRIPTION OF THE CURRENTLY PREFERRED EMBODIMENTS

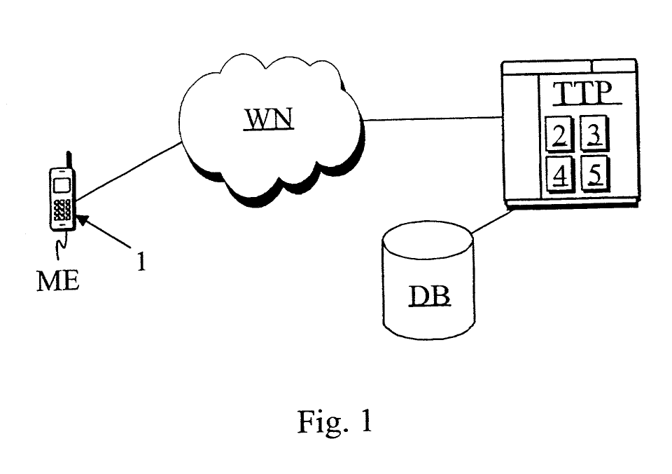

The system of the invention as depicted in FIG. 1 comprises a mobile station ME, a telecommunication network WN, a trusted third party TTP and a database DB. The mobile station ME and trusted third party TTP are connected to the telecommunication network WN, which is preferably a mobile communication network. The database DB, which is associated with or maintained by the trusted third party TTP, stores information relating to specific property. The tasks of the trusted third party TTP may include the creation of digital signing and/or encryption keys, registration of users, certification of public keys, publication of public keys and certificates, and updating and publication of key and certificate revocation lists.

Mobile station ME includes signing equipment 1 for digitally signing a property identifier with a certified signing key. The signing equipment 1 may for example be implemented by a software-based application such as is generally known in the art and stored on the mobile station. In preferred forms of the invention, the identifier is a serial number that is somehow attached or affixed to or in or on an article or other object. That the public signing key is certified means that the trusted third party TTP has verified that the user of the key holds or owns the private key that corresponds to that public key. The signing key may be, as is preferred, a program or data block. The mobile station ME may also be provided with a redundant telecommunication interface in which the connection to the communication system is implemented using Bluetooth technology, IrDa or an inductive connection or the like.

In the particular system shown in FIG. 1, the trusted third party comprises a modifier 2 that is used to attach to the signed identifier data relating to the signatory. A first checker 3 is used to verify the validity of the signing key of the signatory, and a second checker 4 is used to verify the signature associated with the identifier from the database DB. The modifier 2, first checker 3 and second checker 4 may advantageously be implemented by a program block or software-based application.

Using the FIG. 1 embodiment of the inventive system, a user may for example wish to list or register a valuable camera as his or her property. Before doing so, the user must enter into a service contract, as with a service operator that is offering property management services. These services and activities may also be provided directly by the trusted third party as service operator. In any event, the user becomes registered and provides to the service operator appropriate or requested or required information about him or herself which may for example include the user's name, address, telephone number, date of birth, etc. In conjunction with this registration process the service operator may also create the necessary key pair(s) for the user.

To list or register the property, each item to be listed must be assigned or provided with an unambiguous identifier that is unique to that item. In this particular example, where the item is assumed to be a camera, it may by way of illustration be sufficient to attach or affix or imprint an assigned serial number to the body of the camera.

The service operator may, as indicated above, be the party responsible for creating the necessary keys. The user may register the item or property over the user's mobile phone, in which case the keys that have been created for effecting registration of articles must be saved or stored on the mobile phone or on a subscriber identity module (SIM) that is inserted into the mobile phone before listing the article(s) with the service operator. Thus, the user locates the serial number of the camera and creates, using his or her mobile phone, a message that includes at least the located or otherwise defined serial number. To assure that the unique identifier (in the present example the serial number) of the article is authentic and unchanged, it may also be retrieved or located using a separate or different or distinct telecommunication connection, such as a Bluetooth, IrDa, inductive connection or the Internet. In that case the identifier may be received directly by a software application on the mobile station or by another terminal device for use in registering or changing its recorded ownership. As will be appreciated, identifiers other than a serial number or other identifier of the property to be registered—as for example a unique number of a Bluetooth circuit or a fixed IP address or combination thereof. An identifier of the terminal device itself may also be verified, in which case it may be retrieved using the internal bus of the terminal device itself.

The user digitally signs the serial number or other article identifier with his or her private signing key, and then transmits the message to the service operator. The message communication between the user and service operator may also be encrypted with the public key of the service operator prior to transmission of the encrypted and digitally signed message. Where the user's mobile station is utilized as the registration terminal it is advantageous to employ a registration form that is delivered to the mobile station which may be implemented for receiving the required variable information from the user and then sending that information to the database service as a digitally signed and preferably encrypted short message (SMS) in a predetermined, fixed format.

The service operator may verify the validity of the user's key when receiving the signed message. The service operator may also sign the received message using the private signing key of the service operator to assure that the signed information cannot be altered without detection. The information signed by the service operator is then saved and stored, as to the database DB specifically maintained for this purpose.

When the unique identifier has been registered in the database DB, the database or the trusted third party sends to the holder of the signing key a signed acknowledgement message to thereby notify the owner of the article that the registration has successfully been effected. The registration message may also be directly sent to the registered device, such as the mobile station MS; in this case the mobile station or the like is capable of identifying its owner based on the private key of the terminal device, and only after this verification will it become activated or cease permitting only a restricted right of use. In conjunction with this registration, the owner of the property being registered may, in addition, place use restrictions on the device, such as the identifiers of other permitted users or certificates, and this additional information may also be attached to the registration acknowledgement message.

In this manner, the user may within any coverage area of the mobile phone and at any time provide to a trusted third party (in this case the service operator), securely and with absolute certainty, verifiable information regarding his or her property.

The system of FIG. 1 may be used in a variety of circumstances to, for example, verify the identity of the alleged owner of particular property, Thus, a potential purchaser of a precious article or a second-hand article may wish to confirm the identity of the current owner of the property before making the purchase, and the inventive system readily enables such a secure and trustworthy determination.

Where, for example, a potential purchaser is interested in acquiring a valuable camera from the current owner, he or she can check the serial number on the body of the camera and then create, with his or her mobile phone, an interrogation message that contains at least that serial number. The user signs the interrogation message with his or her private signing key and transmits the message to the service operator. The service operator receives and checks and identifies the message based on the sender's signing key, and then retrieves from the database the information that has been stored for the serial number contained in the interrogation message. If the serial number is found in the database, then the associated stored information—containing the current ownership details for the article identified by that serial number—is returned to the user as a response to the interrogation message. Since the ownership information stored in the database has been signed with the private signing key of the service operator, the interrogating user may then use his or her mobile phone to verify that the sender of the response to the interrogation message is actually the person he or she is claiming to be, i.e. the service operator. The mobile phone user is thus able to determine whether the person seeking to sell the camera is actually the current owner; if the personal data of the person selling the camera matches the information received in the responsive message from the service provider, then the purchase may safely proceed. When the sale of the camera has been completed, the former owner can cancel his or her recorded ownership by transmitting to the trusted third party a message informing of the sale, and the camera may then be registered in the name of the new owner.

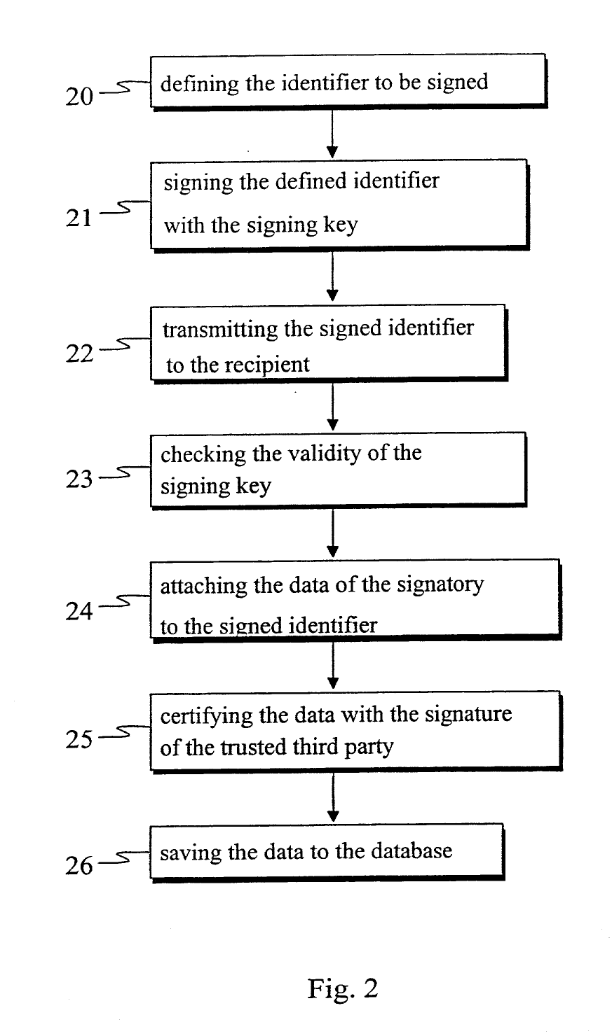

The flow chart of FIG. 2 depicts by way of illustrative example a method of implementing the present invention. The article identifier to be digitally signed is defined at block 20. As discussed above, the identifier is such that it uniquely individualizes the signatory's subject property, and may for example comprise a serial number that is permanently affixed to or on the body of an article. The defined identifier is then digitally signed using the signing key of the signatory, i.e. the owner of the article (block 21). It is assumed in this example that the signatory has entered into some kind of service contract or agreement with the service operator, here advantageously assumed to be a trusted third party. In entering into the contract the trusted third party creates the signing keys for the client and, optionally, the client's public and private encryption keys. The client may, if it is necessary or desired to encrypt the message communication between the client and trusted third party, be given the public key of the trusted third party.

The article identifier, digitally signed by the article owner/client, is then transmitted to the trusted third party recipient (block 22), who is in this case also the service operator. If it is necessary or desired to encrypt communication between the client and service operator, the client first encrypts the message to be sent using the public key of the trusted third party. The trusted third party can then open the encrypted message using the corresponding private key of the trusted third party.

At block 23, the trusted third party checks the validity of the signing key of the client from whom the digitally signed identifier has been received. If the key is not valid, a notification message informing the client of the expired signing key is attached to the received identifier and returned to the client from whom the signed identifier was received. If on the other hand the key is verified to be valid, then the identifier is entered into the database as certified. In addition, information (as defined or specified in the service contract) is attached to or otherwise associated with the signed identifier (block 24). Such attached information may for example include the name, address, etc. of the verified owner of the article. The trusted third party certifies the integrity of the attached information by signing it with the private signing key of the trusted third party (block 25), and the digitally signed information certified by the trusted third party is saved to the database (block 26).

In one use or implementation of the inventive method, the article to be registered may be a device or a piece of software designed to effect a particular restriction of use. Thus, the registration may by way of illustration be intended to so restrict its use that the device may only be used for a certain limited period of time or for a limited number of minutes or hours or days, or only within a predetermined service area that is identified or updated (as to current position) using geographical information delivered by a GPS positioning unit. The device in this case may accordingly be a rental car or a vehicle provided to a potential purchaser for a test drive and equipped with a computer programmed to permit use of the vehicle only within a certain region and/or for a preset period of time or distance of travel. The permissible route to return the vehicle to the place of delivery in the presence of certain persons might also be restricted. These usage restrictions can only be changed by an acknowledgement message of a registering authority or a registration database service and/or by a digitally signed acknowledgement message of the recorded owner. To implement these restrictions and functionalities, stored certificates of the various entities involved and a telecommunication connection for use in verifying the authenticity of the certificates from an external, trusted database must be maintained or readily available.

To prevent misuse of the database, as for the unauthorized use of ownership related information, a person wishing to become registered may in a signed message sent by him or her inform the authorities of the permissible visibility of the information or declare the information public. Then, if the user's property is subsequently stolen, database queries may be permitted to enable one who locates the stolen article to determine its ownership from the information stored in the database.

Where the marked property is itself operable for establishing a telecommunication connection directly with the database service or through a terminal device or mobile station of the owner, then in the event of a theft or loss of the device a message, signed by the owner and/or the registration service, may be sent directly to the device (based on its IP address or the like) informing the current holder of the device that it has been locked to prevent its further use. This capability makes it particularly advantageous to include the IP address of such a device as at least a part of the identifier (and its associated information) to be registered.

Where the property includes a Bluetooth or other wireless connection, verification and identification of articles can be implemented through checking points variously located at airports or railway stations or along streets or highways. This can provide a particularly effective way of locating stolen property and automatically transmitting notification thereof to the authorities. Where such devices include geographic position determination abilities, the geographic location of the stolen device may likewise be transmitted for tracking via the wireless or other communication connection.

While there have shown and described and pointed out fundamental novel features of the invention as applied to preferred embodiments thereof, it will be understood that various omissions and substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same result are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method of managing user property using a public key infrastructure having keys for at least one of digital signing and encryption in a telecommunication network that includes a database for storing registered user information and a mobile station of the user that contains a certified private signing key of the user, comprising the steps of:
creating an unambiguous identifier for the property of the user to be managed;
creating in the mobile station a message that includes the identifier digitally signed with the certified private signing key of the user;
sending the created message from the mobile station to a service provider;
attaching, at the service provider, user information to the identifier received in the sent message; and
storing the received identifier with the attached user information in the database to thereby register the property of the user.

2. The method of claim 1, further comprising the steps of:
encrypting the signed identifier with a public key of a public-private encryption key pair of the user; and
decoding the encrypted signed identifier using a private key of the public-private encryption key pair of the user.

3. The method of claim 1, further comprising the step of checking validity of the private signing key of the user that has been used to digitally sign the identifier and, if the key is determined to not be valid, attaching to the identifier a notification that the private signing key is expired.

4. The method of claim 1, further comprising the step of checking validity of the private signing key of the user that has been used to digitally sign the identifier and, if the key is determined to be valid, entering the identifier in the database as certified.

5. The method of claim 1, further comprising the step of creating the encryption key pair and a digital signing key pair and certifying the key pairs with a certificate of a trusted third party.

6. The method of claim 1, further comprising the step of digitally signing, with a private encryption key of a trusted third party, the identifier and user information attached to the identifier.

7. The method of claim 1, further comprising the steps of:
sending a query to the database;
sending, in response to the query, an information message including the digitally signed identifier; and
checking the digital signature of the digitally signed identifier to determine, from the information attached to the signed identifier, the registered user that owns the property.

8. The method of claim 1, wherein the identifier comprises at least one of a unique serial number of the property, a unique number of a Bluetooth circuit, and a fixed IP address.

9. The method of claim 1, further comprising the step of checking validity of the private signing key of the user that has been used to digitally sign the identifier as received by the service provider.

10. The method of claim 1, wherein the identifier comprises a serial number.

11. The method of claim 1, further comprising the step, after the step of storing the received identifier with the attached user information in the database, of sending a certification message to the user as registered holder of the signing key.

12. The method of claim 1, wherein said step of creating the message further comprises encrypting the message that includes the identifier digitally signed with the certified private signing key of the user using a public encryption key of the service provider, and wherein said step of sending the created message from the mobile station to the service provider further comprises sending the created message to the service provider after said encrypting of the message with the certified private signing key of the user, said method further comprising the step of decrypting, at the service provider, the encrypted message received by the service provider from the mobile station.

13. A system for managing property of a user in a telecommunication network that includes a user terminal having a public encryption key of an encryption key pair of the user and a certified private signing key of a digital signing key pair of the user, a service provider, and a database for storing registered user information, said system comprising:
an identifier unambiguously related to the property to be managed;
means in the user terminal for digitally signing the identifier;
means at the service provider for attaching user information to the digitally signed identifier; and
checkers for verifying digital signatures.

14. The system of claim 13, wherein said checkers includes a first checker for verifying validity of the private signing key used to digitally sign the identifier.

15. The system of claim 13, further comprising a trusted third party.

16. The system of claim 13, wherein said checkers includes a second checker for verifying a digital signature connected with the identifier from the database.

17. The system of claim 14, wherein said checkers includes a second checker for verifying a digital signature connected with the identifier from the database.

18. The system of claim 13, further comprising a telecommunication connection for transmission of at least one of signed and encrypted information between the user terminal and the service provider.
